(19) United States
(12) Patent Application Publication
(10) Pub. No.: US 2013/0212922 A1
(43) Pub. Date: Aug. 22, 2013

(54) OPTICAL DEVICE HAVING LIGHTWEIGHT HOUSING

(71) Applicants: Mark A. Thomas, Sisters, OR (US); Michael A. Shantie, Redmond, OR (US)

(72) Inventors: Mark A. Thomas, Sisters, OR (US); Michael A. Shantie, Redmond, OR (US)

(73) Assignee: YT Products LLC, Sisters, OR (US)

(21) Appl. No.: 13/537,841

(22) Filed: Jun. 29, 2012

Related U.S. Application Data
(60) Provisional application No. 61/588,551, filed on Jan. 19, 2012.

(51) Int. Cl. F41G 1/387; B29C 45/14; G02B 7/00; F41G 1/00

(52) U.S. Cl. 42/119; 42/143; 264/257; 359/894

(57) ABSTRACT

A rifle sighting system, that includes a metal base assembly and a train of optical elements affixed to the base assembly, and including a front optical element having a front surface and having a rear optical element having a rear surface. A cover, made of light weight material is affixed to the base assembly and sized and shaped to cover and protect the train of optical elements, other than the front surface of the front optical element and the rear surface of the rear optical element.

### RELATED APPLICATIONS

This application claims priority from application Ser. No. 61/588,551 filed Jan. 19, 2012.

### BACKGROUND

The traditional rifle sighting system body is a tube made of steel or aluminum, having an expanded front (objective) and rear (ocular) section. Although this design has many advantages, there are some optical design goals that are not well served. For example a switchable dual mode sighting system, including both a reflex sight and a telescopic sight, has a rear section that must incorporate the reflex sight. The distinctly-shaped reflex sight is, however, not shaped to fit into a telescopic tube type housing.

This type of sighting system is better served by a housing that is made of a bottom mounting plate assembly, to which optical assemblies are affixed, and to which an upper, optical assembly-covering housing portion is also affixed. This type of housing, however, may result in a sighting-system weight that is greater than desirable. Although a number of well-known materials exist for addressing this problem, there has been a great challenge in originating a design that utilizes differing materials but results in a sighting system that is robust enough to withstand the violent shock of rifle recoil. Moreover, reducing weight in a rifle scope is generally a desirable design goal.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In a first separate aspect, the present invention may take the form of a rifle sighting system, which includes a metal base assembly and a train of optical elements affixed to the base assembly. This includes a front optical element having a front surface and a rear optical element having a rear surface. A cover, made of light weight material is affixed to the base assembly and sized and shaped to cover and protect the train of optical elements, with the exception of the front surface of the front optical element and the rear surface of the rear optical element.

In a second separate aspect, the present invention may take the form of an optical device having a front and a rear, and including an optical train, including an objective lens and a housing that holds, supports and protects the optical train, and which includes at least a portion made of woven fiber material. An objective lens holder defines a rearward facing slot and is at least partially circumferential to the objective lens and wherein at least the fiber portion of the housing includes an edge that is retained in the slot.

In a third separate aspect, the present invention may take the form of an optical device having a front and a rear, and including an optical train, including a rearmost transparent element, adapted to present an image to a viewer. A housing holds, supports and protects the optical train, and includes at least a portion made of fiber material. Also, a rearmost transparent element holder defines a forward facing slot that is at least partially circumferential to the rearmost transparent element. Also, at least the fiber portion of the housing includes an edge that is retained in the slot.

In a fourth separate aspect, the present invention may take the form of a method of creating an optical device, which makes use of an optical element assembly, including an optical element in an optical element holder, which includes two closely spaced walls defining a groove. Adhesive is put between the walls. A housing wall, having a thickness such that it will fit between the two closely spaced walls, is pushed between the walls. Finally, the adhesive is permitted to cure.

In a fifth separate aspect, the present invention takes the form of a method of producing a telescope having a composite-material body. The method utilizes a longitudinal inner molding core (henceforth designated by industry term “spud”), defining a front and a rear and about which is placed an annular front composite-material anchor and an annular rear composite-material anchor. Woven-fiber material is placed about the spud, the front composite-material anchor and the rear composite-material anchor, thereby creating a work piece. The work piece is placed into a mold and a charge of a resin is introduced. The mold is closed and the work piece and the resin are heated until the resin spreads throughout the woven-fiber material and cures. The mold is then opened and the work piece is removed. The spud is removed from the cured woven material, thereby providing a housing of woven-fiber material, infused with cured resin, anchored to the front and rear composite-material anchors. The composite-material housing is then used as a part in the construction of a telescope.

In a sixth separate aspect, the present invention may take the form of an optical assembly, comprising a front annular composite material anchor and a rear annular composite material anchor. Also, a tube of rigid composite material is affixed circumferentially to both the front anchor and the rear anchor and a train of optical elements are housed within the tube.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced drawings. It is intended that the embodiments and figures disclosed herein are to be considered illustrative rather than restrictive.

FIG. 1 is an exploded perspective view of a dual mode rifle scope according to the present invention.

FIG. 2 is a perspective, not exploded, view of the rifle scope of FIG. 1.

FIG. 3 is a sectional view of the rifle scope of FIG. 1, taken along line 3-3 of FIG. 2.

FIG. 4 is an expanded detail sectional view of the area indicated by circle 4 of FIG. 3.

FIG. 5 is a sectional view of the rifle scope of FIG. 1, taken along line 5-5 of FIG. 2.

FIG. 6 is an expanded detail view of the area indicated by circle 6 of FIG. 5.

FIG. 7 is a sectional view of the rifle scope of FIG. 1, taken along line 7-7 of FIG. 2.

FIG. 8 is an expanded detail view of the area indicated by circle 8 of FIG. 7.

FIG. 9 is a partial cut-away view of a pair of binoculars, according to the present invention.

FIG. 10 is an expanded detail view of the area indicated by circle 10 of FIG. 9.

FIG. 11 is an exploded view of a spud, adapted to facilitate the production of a scope having a housing made largely of fiber composite material.

FIG. 12 is an isometric view of the work piece of FIG. 11.

FIG. 13 is a detail view of circle 13 in FIG. 12.

FIG. 14 is an isometric view of the work piece of FIG. 12, partially covered in a woven fiber tube

FIG. 15 is an isometric view of the tube covered work piece of FIG. 14, set into a mold.

FIG. 16 is an isometric view of a finished work piece, representing a portion of a rifle scope housing.

FIG. 17 is an isometric view of a rifle scope incorporating the portion of FIG. 16.

### DETAILED DESCRIPTION OF THE PREFERRED EMBODIMENT(S)

### Definitions:

When the term “metal” is used as a modifier in this application, it means that the item that is the object of the modifier is largely metal, but could include other materials as well.

When the term “composite material” is used in this application, it means an engineered material made from two or more constituent materials with significantly different physical properties which remain separate and distinct within the finished structure. The term includes materials that combine a substrate of woven fibers, infused with a resin. The woven fibers may be made from carbon fibers, basalt fibers, glass fibers or para-aramid synthetic fibers. The resin may include an epoxy, polyester, nylon or vinyl ester. Also included are laminated materials made, at least in part, of composite material layers, and which may have a first layer or set of layers, made of a first composite material, and a second layer or set of layers, made of a second composite material. The term “composite-material” is a modifier indicating that the object of the modification interfaces with composite material.

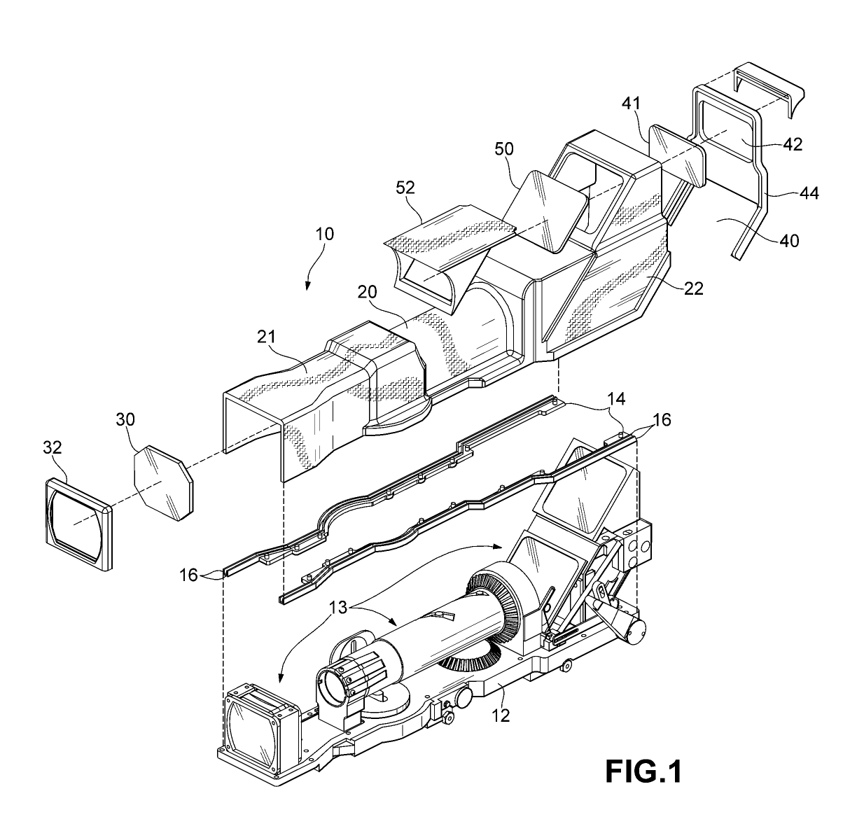

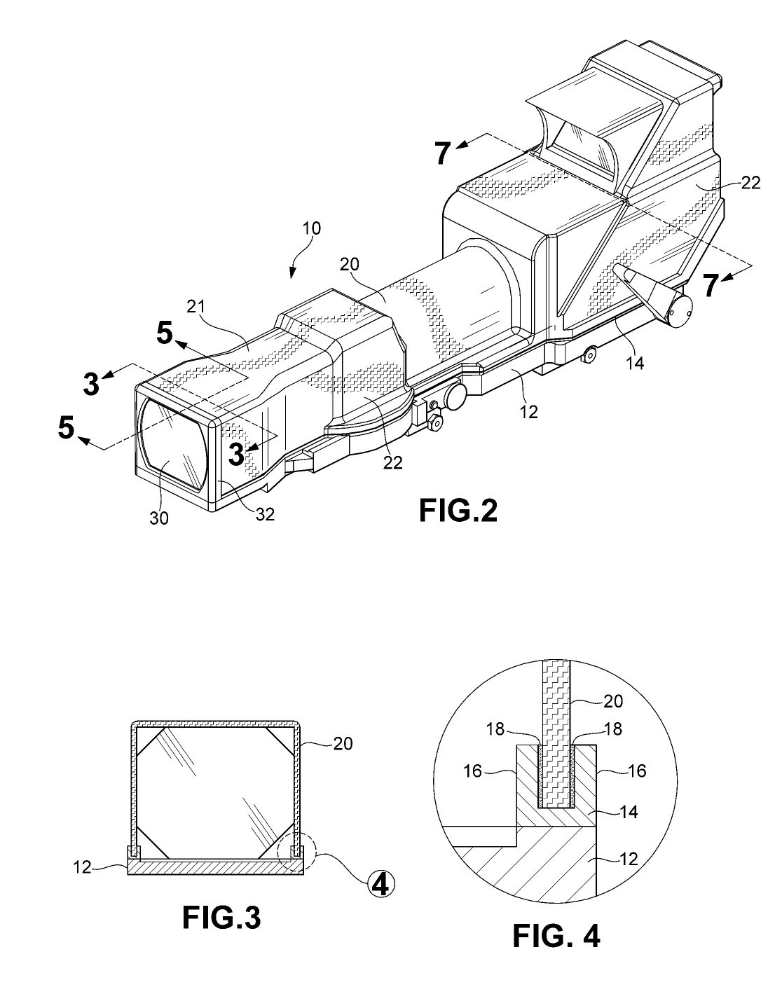

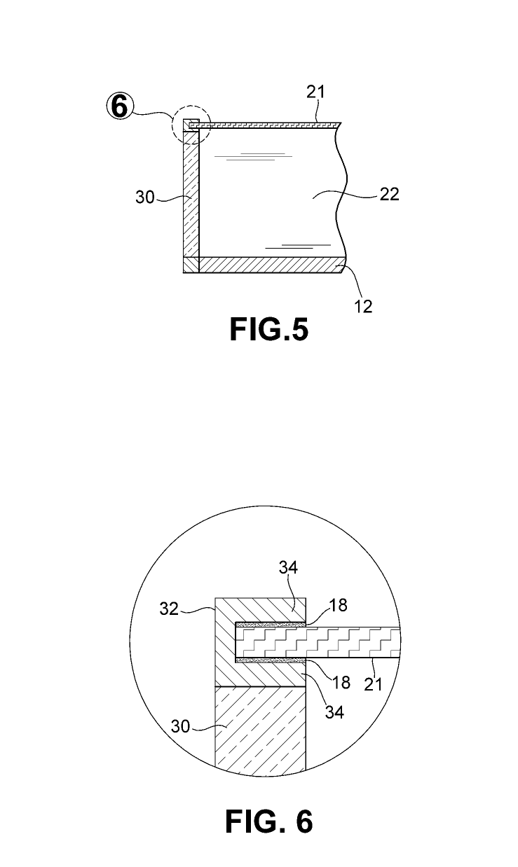

Referring to FIG. 1, a preferred embodiment of an optical device, according to the present invention, may take the form of a dual mode rifle scope 10, which in a first mode is a reflex sight and in a second mode is a telescopic sight (commonly known as a scope). A bottom mounting structure 12 supports an optical element assembly 13 and a pair of rails 14, which in one preferred embodiment, are fastened on structure 12 with threaded fasteners. In another preferred embodiment they are attached to structure 12 with rivets or adhesive or both. Each rail 14 has a groove defined between a pair of upwardly extending short (2-3 mm) walls 16. Epoxy adhesive 18 (FIG. 4) is introduced into this groove and a cover 20, having a top wall 21 and a pair of side walls 22 (FIG. 5) is lowered onto rails 14, with each side wall 22 being introduced into one of the grooves defined by walls 16. In a preferred embodiment cover 20 is made of carbon or basalt fibers woven together and covered with an air-tight coating, preferably of epoxy. For the purposes of this application, any sheet material having an area density of less than 0.2 grams/cm² is considered to be lightweight.

At this stage of assembly, the work piece now has an optical train held in place on a strong metal mounting structure 12, and covered by a very lightweight yet robust cover 20, that is securely attached to mounting rails 14. But the front and rear light windows have not been attached. To do this a front light window 30 is placed in a metal holder 32 that includes a pair of closely spaced walls 34 (FIG. 6) projecting rearward from the top rim and side rims of holder 32 (FIGS. 5 and 6 show walls 34 on top rim). The top wall 21 and sidewalls 22 are pushed into the groove defined by walls 34, which has been filled with adhesive 18. A sealing gasket (not shown) is installed between holder 32 and mounting structure 12, to prevent moisture from seeping into the interior of scope 10.

A similar procedure is employed with the rear windows, which for this embodiment include a telescopic rear window in space 40 (FIG. 1) and a reflex rear window 41 in space 42 (FIG. 1). A window holder 44 also includes a pair of closely spaced walls 46 (FIG. 8), which are filled with adhesive 18 before sidewalls 22 are pushed in. In addition a reflex sight window 50 is kept in place by a window cover 52.

The holders 32 and 44 of both front window 30, and rear windows 40 and 50 are held in place only by the carbon fiber cover 20, and are light-weight, preferably made of aluminum and transparent polymer material, respectively. Accordingly, they do not have inertia to the extent that the heavier internal lenses have, to resist the sudden acceleration caused by rifle recoil. Also, if windows 30, 40 and 50 move slightly forward or rearward due to repeated recoil, this does not affect the final image, as windows 30, 40 and 50 only transmit light. Therefore, in contrast to elements of the optical train, the distance separating these windows from other optical elements is not critical.

Accordingly, after the adhesive cures, a scope that is both robust, as the optical train is supported by metal structure 12, and light, due to the lightness of carbon fiber cover 20, is produced. Although this optical device has been shown with reference to a dual mode sight, it should be emphasized that the optical device could be single mode telescopic sight or reflex sight, still providing the advantage of robust construction and light weight.

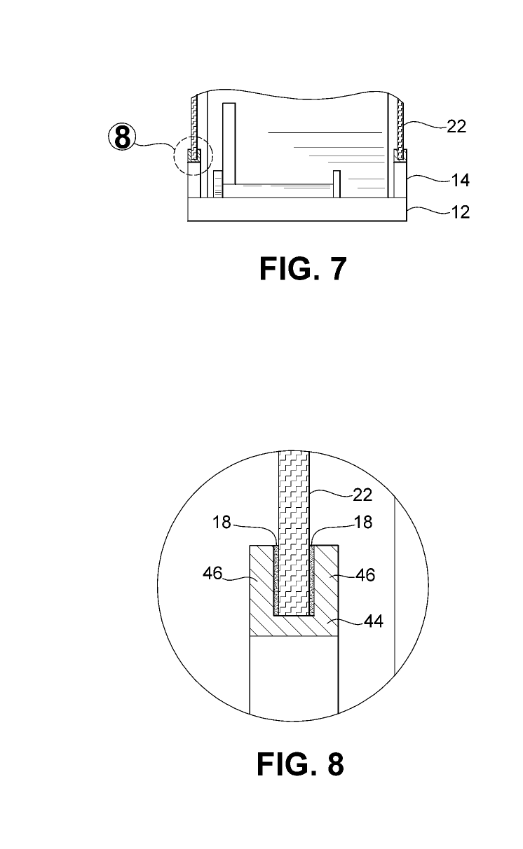

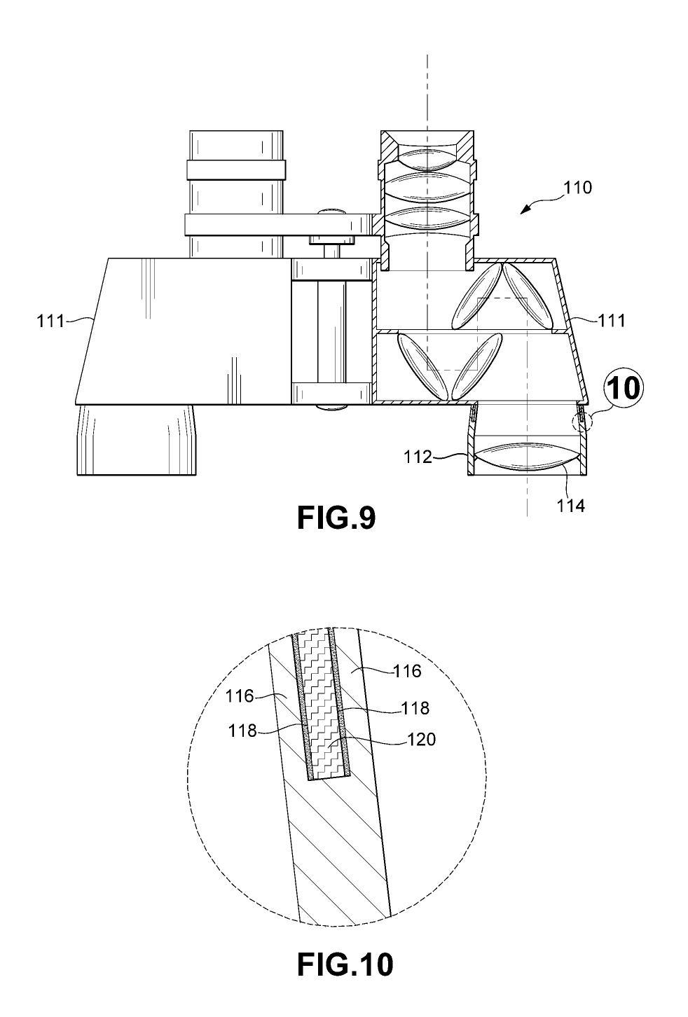

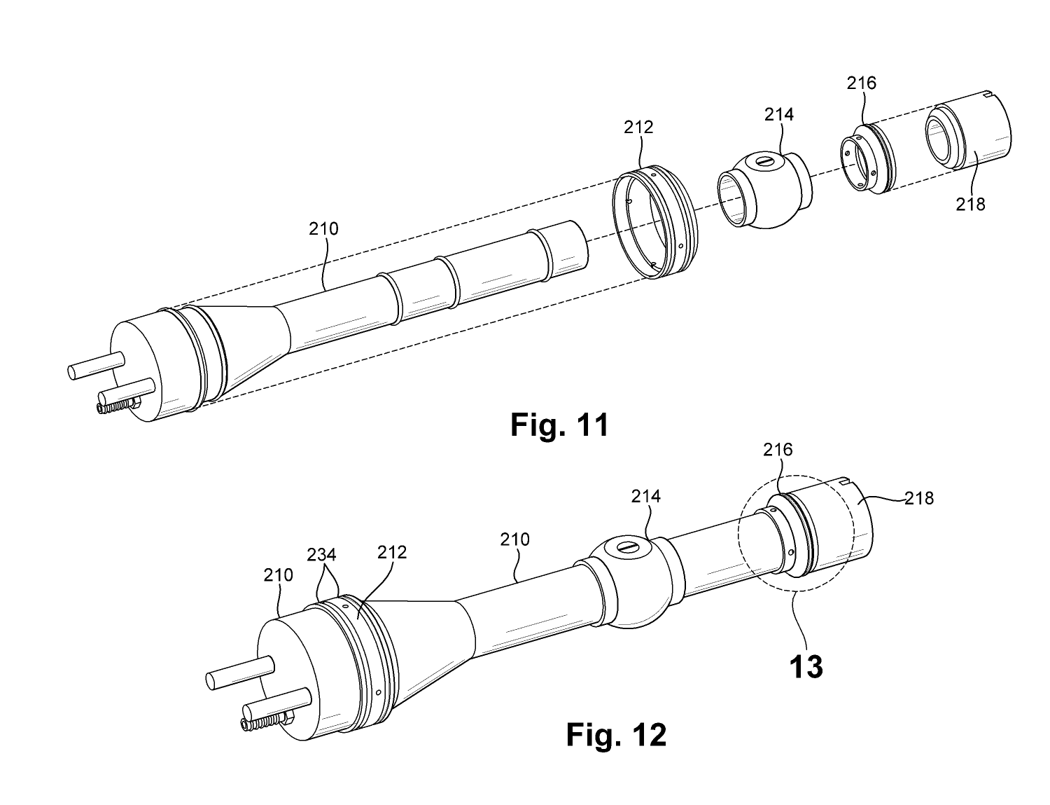

Referring to FIGS. 9 and 10, one preferred embodiment takes the form of a pair of binoculars 110, which is made up of two identical tubes 211, hinged together. Similar to the technique used in FIGS. 5-8, a lens holder 112 holds an objective lens 114 and defines a pair of closely spaced walls 116 (FIG. 10) which are filled with adhesive 18, prior to receiving a carbon fiber wall 120. Binoculars do not suffer recoil shock, so the body of the scope itself is strong enough to hold the internal optics in place.

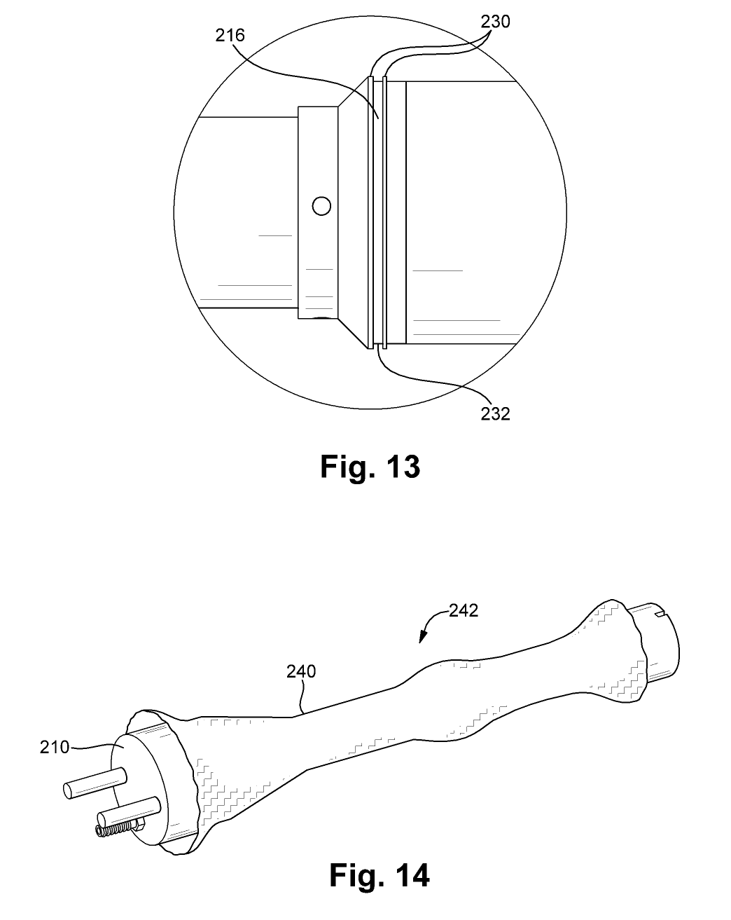

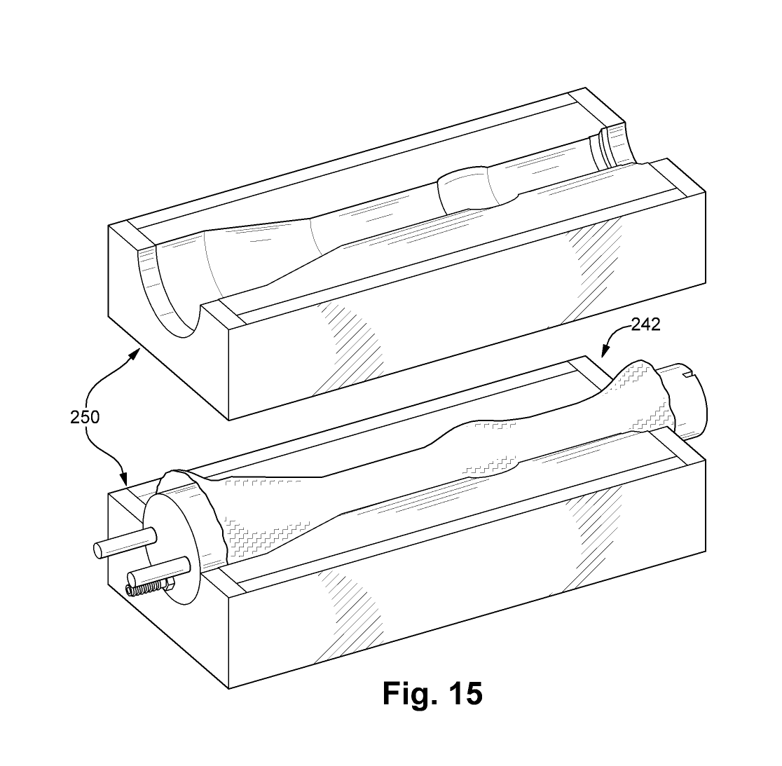

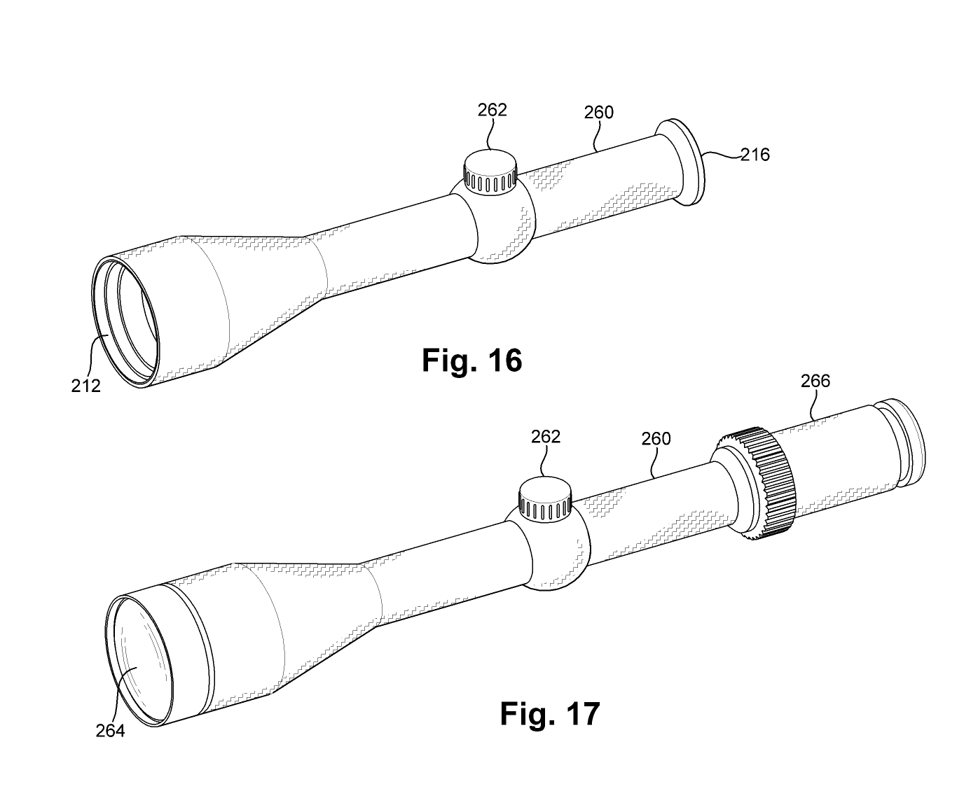

Referring to FIGS. 11-17, in an alternative preferred embodiment for a telescopic sight is formed by first providing a spud 210, generally in the shape of a scope. An annular front composite-material anchor 212 (made of metal) is threaded onto spud 210, together with an elevation and windage adjust mechanism 214 and a rear composite-material anchor 216. A further rear piece 218 is fit to the rear of anchor 216, to facilitate production handling. Rear anchor 216 includes two radial ridges 230 (FIG. 13) that define a radial groove 232 (FIG. 13), which acts to accept and anchor the composite material 260 (FIG. 16). In similar manner, annular ribs 234 help to bind composite material 260 to the front anchor 212 (FIG. 11). Referring to FIG. 14, woven material 240 is then placed about spud 210 (now supporting anchors 212 and 216 and mechanism 214) and the resultant work piece 242 is placed into a mold 250 (FIG. 15). Mold 250 is closed about work piece 242, with a charge of epoxy MGS Epoxy-285 resin, with a mix ratio of 2:1 epoxy to hardener, which is available from www.cstsales.com and is heated to about 49° C. for about 14 hours, curing the epoxy, and forming a composite material housing portion 260.

Referring to FIGS. 16 and 17 at the end of the process, composite material housing portion 260 is cut away from where it is not needed, such as at the top and right side of elevation and windage adjust mechanism 214, so that an elevation knob 260 and a windage knob (not shown) can be installed onto mechanism 214. In an alternative preferred embodiment, an elevation and windage adjust mechanism, similar to mechanism 214, is fit over holes cut in composite material housing portion 260 at the right places, and after spud 210 is removed, the interior working assembly of the elevation and windage adjust mechanism is entered into the scope, together with other interior components (see below).

The rear handling facilitating piece 218 is removed. Finally, an objective lens assembly 264 is installed onto the front of anchor 212, an erector tube and other necessary elements are fit into housing portion 260 and an ocular assembly 266 is attached to the rear anchor 216 to create a finished rifle scope that is lighter than currently available scopes of similar dimension.

While a number of exemplary aspects and embodiments have been discussed above, those possessed of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A rifle sighting system, comprising:
(a) a metal base assembly;
(b) a train of optical elements affixed to said base assembly, and including a front optical element having a front surface and having a rear optical element having a rear surface; and
(c) a cover, made of lightweight material, affixed to said base assembly and sized and shaped to cover and protect said train of optical elements, with the exception of said front surface of said front optical element and said rear surface of said rear optical element.

2. The rifle sighting system of claim 1, wherein said rear optical element is a first rear optical element and including a second rear optical element, which also has a rear surface and wherein said rear surface of said second rear optical element is also not covered and protected by said cover.

3. The rifle sighting system of claim 1, wherein said base assembly includes a metal rail assembly providing a vertical surface to which said cover is attached.

4. The rifle sighting system of claim 3, wherein said metal rail assembly includes two parallel closely spaced walls, thereby defining a slot therebetween, and wherein said cover defines cover edges which are held in said slot.

5. The rifle sighting system of claim 4, wherein said cover edges are held in said slot adhesively.

6. The rifle sighting system of claim 5, wherein said cover edges are held in said slot with epoxy adhesive.

7. The rifle sighting system of claim 1, wherein said cover is made of a fiber-adhesive composite material.

8. The rifle sighting system of claim 7, wherein said cover is made of carbon fiber-adhesive composite material.

9. The rifle sighting system of claim 1, further including a front optical element frame, in which said front optical element is retained, and wherein said front optical element frame has a top and two sides and wherein said top and two sides include attachment features for facilitating the attachment of said cover.

10. The rifle sighting system of claim 9, wherein said attachment features include a pair of closely spaced walls defining a slot, and wherein said cover defines edges and said edges are retained in said slot.

11. The rifle sighting system of claim 10 wherein said edges are adhered in said slots.

12. A method of producing a telescope having a composite-material body, comprising:
(a) providing a longitudinal spud, defining a front and a rear;
(b) placing an annular front composite-material anchor about said spud at said front;
(c) placing woven-fiber material about said spud and said front composite-material anchor, thereby creating a work piece; and
(d) placing said work piece into a mold and introducing a charge of a resin;
(e) closing said mold and heating said work piece and said resin until said resin infuses said woven-fiber material and cures;
(f) opening said mold and removing said work piece;
(g) removing said spud, thereby providing a housing of woven-fiber material, infused with cured resin and anchored to said front composite-material anchor; and
(h) using said housing as a part in the construction of a telescope.

13. The method of claim 12, wherein said composite material anchor is made of metal.

14. The method of claim 12, wherein said resin is epoxy.

15. The method of claim 12, wherein said woven-fiber material is carbon fiber material.

16. The method of claim 12, wherein said woven-fiber material is basalt fiber material.

17. The method of claim 12, further including the step of placing an annular rear composite-material anchor about said spud at the rear and wherein step (c) further includes placing said woven material about said rear composite-material anchor, and wherein said rear composite-material anchor includes at least one radially outwardly projecting pair of ridges, defining a groove therebetween, for accepting said woven-fiber material and forming an enhanced bond with said finished composite material, once finished.

18. The method of claim 12, wherein said front anchor includes radially interior features adapted to permit the attachment of an objective lens holder.

19. An optical assembly, comprising:
(a) a front annular composite material anchor;
(b) a rear annular composite material anchor;
(c) a tube of rigid composite material, affixed circumferentially to both said front anchor and said rear anchor; and
(d) a train of optical elements within said tube.

20. The optical assembly of claim 19, wherein said train of optical elements includes an erector tube that is mounted so as to be moveable in azimuth and elevation and wherein a mechanism for changing elevation and windage angle of said erector tube is retained partially in said tube but includes a post that breaches said tube and a knob on said post, outside of said tube, for permitting a user to turn said knob and change said elevation angle of said erector tube.

21. The optical assembly of claim 19 further including an objective lens assembly, attached to said front annular composite material anchor.

22. The optical assembly of claim 19 further including an ocular lens assembly, attached to said rear annular composite material anchor.

23. The optical assembly of claim 19, wherein said front annular anchor has a greater diameter than said rear annular anchor.

24. The optical assembly of claim 23, wherein said tube expands in diameter in its front one-third portion.

25. The optical assembly of claim 19, wherein said front and rear composite material anchors are made of metal.

26. The optical assembly of claim 19, wherein paragraphs (a) through (d) describe a first tube of a pair of binoculars and wherein a second identical tube is provided, hinged to said first tube.

27. The optical assembly of claim 19, more specifically being a rifle scope.
